(19) United States
(12) Patent Application Publication
(10) Pub. No.: US 2020/0166726 A1
(43) Pub. Date: May 28, 2020

(54) LENS MODULE

(71) Applicant: AAC Optics Solutions Pte. Ltd., Singapore City (SG)

(72) Inventor: Hailong Wang, Shenzhen (CN)

(21) Appl. No.: 16/695,048

(22) Filed: Nov. 25, 2019

(30) Foreign Application Priority Data
Nov. 27, 2018 (CN) 201821969339.2

(51) Int. Cl. G02B 7/02

(52) U.S. Cl. CPC G02B 7/021; G02B 1/041

(57) ABSTRACT

The present disclosure provides a lens module, which includes a lens barrel and a lens group. The lens barrel includes a first barrel wall configured with a light through hole. The first barrel wall includes a first surface adjacent to an image side and a second surface adjacent to an object side. The lens barrel has an inner wall. The lens group at least includes a first lens. The first lens includes an optical portion and a peripheral portion surrounding the optical portion. An object side surface of the peripheral portion of the first lens includes at least two protrusions evenly distributed along a circumference of the first lens, and the protrusion protrudes from the first lens towards the first barrel wall. The first surface includes a first recess corresponding to the protrusion; and the protrusion is accommodated and fixed in the first recess.

### TECHNICAL FIELD

The present disclosure relates to the field of camera lenses, and particularly relates to a lens module.

### BACKGROUND

With the continuous development of science and technology, electronic devices are continuously developing towards intelligence, and portable electronic devices such as tablet computers, cell phones and the like are also equipped with lens modules, except for digital cameras. In order to meet the needs of people, higher requirements for image quality of an object photographed by lens modules are also put forward.

However, in available lens structure, an outer diameter part of a first lens is generally matched with an inner wall of a lens barrel, and due to the poor dimensional precision of an outer diameter of glass lenses, poor assembly may often occur, which affects the performance of a lens. The current matching manner still has much room for improvement. In order to realize more stable matching between glass lenses and various components, and improve the overall performance of the lens, it is necessary to provide a new type of lens module.

### BRIEF DESCRIPTION OF THE DRAWINGS

FIG. 1 is a structural sectional view of a lens module of the present disclosure;

FIG. 2 is a structural sectional view of the lens module of the present disclosure from another angle;

FIG. 3 is a section view of a structure of a lens barrel of the present disclosure;

FIG. 4 is a stereostructure view of a first lens of the present disclosure; and

FIG. 5 is a plan view of the first lens of the present disclosure.

### DETAILED DESCRIPTION

In order to better understand the solutions of the present disclosure and advantages thereof in various aspects, the present disclosure will be described in further detail below with reference to the drawings through specific embodiments. In the following embodiments, a left-right direction in a principal plane is taken as a horizontal direction, and a direction in the principal plane perpendicular to the horizontal direction, i.e., an up-down direction in the principal plane is taken as a vertical direction. In the present disclosure, a direction of a central axis is parallel to the vertical direction.

### Embodiment 1

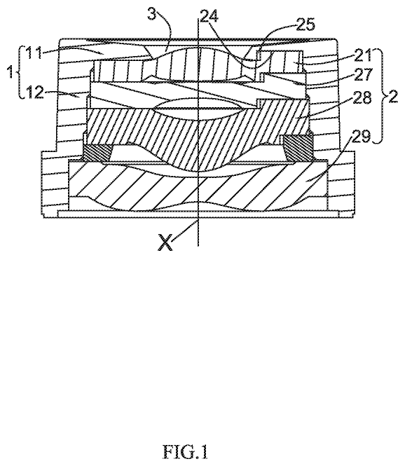

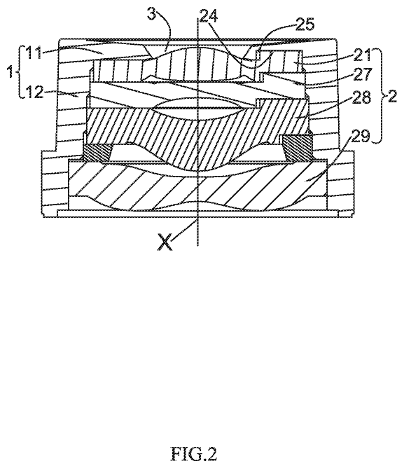

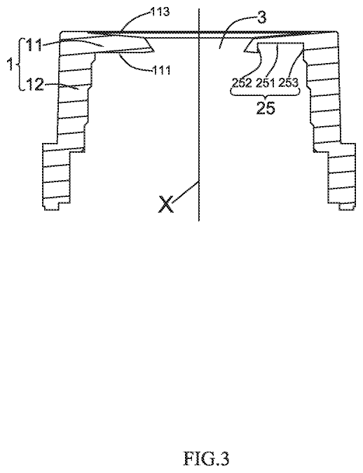

As shown in FIG. 1, FIG. 2 and FIG. 3, the present disclosure provides a novel lens module, which includes a lens barrel 1 and a lens group 2 accommodated in the lens barrel 1, wherein the lens group 2 at least includes a first lens 21 matched with the lens barrel 1.

In the embodiment, as shown in FIG. 3, the lens barrel 1 includes a first barrel wall 11 extending along a horizontal direction and configured with a light through hole 3, a second barrel wall 12 bending and extending from the first barrel wall 11, and an accommodating space defined by the first barrel wall 11 and the second barrel wall 12, wherein the first barrel wall 11 includes a first surface 111 adjacent to an image side and a second surface 113 adjacent to an object side. The lens barrel 1 may either be of an integral structure or a split structure.

In order to improve a matching precision and a yield rate of assembly of the first lens 21 and the lens barrel 1, a structure of the first lens 21 is improved, and the detail solution is as follows.

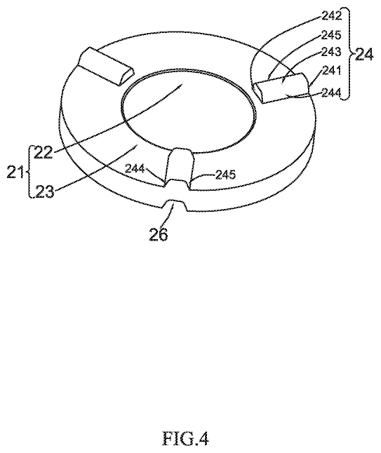

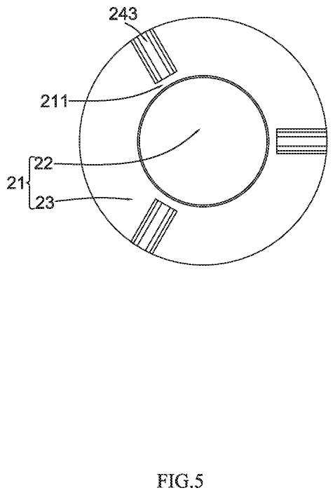

As shown in FIG. 1, FIG. 4 and FIG. 5, an upper surface of the first lens 21 is an object side surface, and a lower surface of the first lens 21 is an image side surface. The first lens 21 includes an optical portion 22 and a peripheral portion 23 surrounding the optical portion 22. The object side surface of the peripheral portion 23 of the first lens 21 includes three protrusions 24 evenly distributed along a circumference of the first lens 21, and the three protrusions 24 are preferably arranged at equal intervals, but may also be arranged at unequal intervals. The protrusion 24 protrudes from the first lens 21 towards the first surface 111 of the first barrel wall 11, and the protrusion 24 is spaced apart from the optical portion 22. The protrusion 24 extends from an outer edge of the peripheral portion 23 towards an optical axis without reaching the optical portion 22. The protrusion 24 includes a first side surface 241 adjacent to the second barrel wall 12 and a second side surface 242 adjacent to the optical axis X, and the first side surface 241 is attached to an inner surface of the second barrel wall 12. The protrusion 24 further includes an upper surface 243 adjacent to the object side, and the upper surface 243 is spaced apart from the first surface 111. The object side surface of the peripheral portion 23 of the first lens 21 further includes a first plane 211 connected with the protrusion 24, the first plane 211 is an annular plane, and the first plane 211 is partially attached to the first surface 111 of the first barrel wall 11.

Further, as shown in FIG. 3, the first surface 111 of the first barrel wall 11 includes a first recess 25 corresponding to the protrusion 24, and the protrusion 24 is accommodated and fixed in the first recess 25. The first recess 25 includes a bottom surface 251, a first side wall 252 and a second side wall 253 both connected with the bottom surface 251 and vertically extending from the bottom surface 251 towards the first lens 21. The first side wall 252 is closer to the optical axis X than the second side wall 253. The first side wall 252 is spaced apart from the second side surface 242 of the protrusion 24, and the second side wall 253 is attached to the first side surface 241 of the protrusion 24. A width of the first recess 25 gradually decreases from the image side to the object side. In detail, it can be seen from FIG. 2 and FIG. 4 that the protrusion 24 further includes a first inclined surface 244 and a second inclined surface 245 extending obliquely and upwardly from the first lens 21. The first inclined surface 244 and the second inclined surface 245 are connected with the upper surface 243 through a smooth transition surface, or are directly connected at an angle. The first inclined surface 244 and the second inclined surface 245 are attached to the inner wall of the first recess 25.

In addition, as shown in FIG. 4 and FIG. 5, the image side of the peripheral portion 23 of the first lens 21 includes a second recess 26 corresponding to the protrusion 24, and the second recess portion 26 is matched with the protrusion 24 in shape, so that the first lens 21 is capable of being matched with a second lens 27 having the same structure as the first lens 21. In addition, the first lens 21 is preferably a plastic lens, but may also be a lens made of other materials.

In the structure above, the three protrusions 24 evenly divide the first lens 21 into three portions which are then matched with the inner wall of the lens barrel 1, so that bearing between the first lens 21 and the lens barrel 1 is smoother, thus not only ensuring an outer diameter precision of the lens, but also ensuring a matching precision of the lens and the lens barrel, and improving the stability of the lens.

In addition, the lens group 2 can further include a second lens 27, a third lens 28, a fourth lens 29, etc. located at the image side of the first lens 21. The second lens 27, the third lens 28, and the fourth lens 29 can be glass lenses, or plastic lenses, or lenses made of other materials. In addition, a number of lenses in the lens group 2 is not limited to four. In addition, a shielding member can be arranged among the lenses, and the shielding member can be a shielding sheet or a shielding plate, but the shielding member can also be omitted.

Compared with the prior art, the lens module of the present disclosure provides improvement of a structure of the peripheral portion of the first lens, which can ensure an outer diameter precision, and is more accurate while being matched with the lens barrel, thus improving the stability of the lens; and has a high matching precision, and is more stable to match with the lens barrel, thus improving an overall performance of the lens.

The description above is merely embodiments of the present disclosure, and it should be pointed out that, those of ordinary skills in the art can make improvements without departing from the inventive concept of the present disclosure, but these all belong to the scope of protection of the present disclosure.

What is claimed is:

1. A lens module, comprising a lens barrel and a lens group accommodated in the lens barrel, the lens barrel comprising a first barrel wall configured with a light through hole and a second barrel wall bending and extending from the first barrel wall, the first barrel wall comprising a first surface adjacent to an image side and a second surface adjacent to an object side; the lens barrel having an inner wall; the lens group at least comprising a first lens matched with the inner wall, the first lens comprising an optical portion and a peripheral portion surrounding the optical portion; wherein an object side surface of the peripheral portion of the first lens comprises at least two protrusions evenly distributed along a circumference of the first lens, and the protrusion protrudes from the first lens towards the first barrel wall; the first surface comprises a first recess corresponding to the protrusion; and the protrusion is accommodated and fixed in the first recess.

2. The lens module according to claim 1, wherein a number of the protrusions is designated as three, and the three protrusions are arranged at equal intervals along the circumference of the first lens.

3. The lens module according to claim 1, wherein the protrusion and the optical portion are arranged at intervals, and the protrusion extends from an outer edge of the peripheral portion towards an optical axis without reaching the optical portion.

4. The lens module according to claim 1, wherein a width of the first recess gradually decreases from the image side to the object side.

5. The lens module according to claim 4, wherein the first recess comprises a bottom surface, a first side wall and a second side wall both connected with the bottom surface and vertically extending from the bottom surface towards the first lens.

6. The lens module according to claim 5, wherein the protrusion comprises a first side surface adjacent to the second barrel wall, and the first side surface is attached to the second side wall.

7. The lens module according to claim 5, wherein the protrusion further comprises a second side surface adjacent to the optical axis, and the second side surface and the first side wall are away from each other.

8. The lens module according to claim 1, wherein the object side surface of the peripheral portion of the first lens further comprises a first plane connected with the protrusion, and the first plane is partially attached to the first surface.

9. The lens module according to claim 1, wherein an image side surface of the peripheral portion of the first lens comprises a second recess corresponding to the protrusion.

10. The lens module according to claim 1, wherein the first lens is a plastic lens.
